(19) United States
(12) Patent Application Publication
(10) Pub. No.: US 2018/0216247 A1
(43) Pub. Date: Aug. 2, 2018

(54) LIGHT METAL BASED MULTI-LAYER SUBSTRATES

(71) Applicant: HEWLETT-PACKARD DEVELOPMENT COMPANY, L.P., HOUSTON, TX (US)

(72) Inventors: CHI HAO CHANG, TAIPEI CITY (TW); KUAN-TING WU, TAIPEI CITY (TW); CHIEN-TING LIN, TAIPEI CITY (TW)

(21) Appl. No.: 15/747,205

(22) PCT Filed: Sep. 11, 2015
(86) PCT No.: PCT/US2015/049605

§ 371 Date: Jan. 24, 2018

(51) Int. Cl. C25D 11/24; C25D 11/02; B05D 7/00

(52) U.S. Cl. CPC C25D 11/246; B05D 7/52; C25D 11/026

(57) ABSTRACT

Substrates comprising a light metal layer, an oxidized layer formed on the light metal layer, and a polymer hybrid layer formed on the oxidized layer; and methods for forming the substrates are disclosed.

### BACKGROUND

An electronic device includes various interconnected components placed in a housing. The housing may be formed using multiple parts made of plastic or metal. In case a housing part is to be made of metal, generally a light metal based substrate is used. The light metal based substrate can impart durability at light weight. The light metal based substrate may be made of, for example, magnesium, aluminum, titanium, lithium, zinc, or their alloys.

### BRIEF DESCRIPTION OF THE DRAWINGS

The accompanying drawings illustrate various examples of the principles described herein and are a part of the specification.

FIGS. 1A and 1B illustrate light metal based multi-layer substrates, according to various examples of the principles described herein.

FIGS. 2 and 3 illustrate examples of light metal based multi-layer substrate, according to various implementations of the principles described herein.

FIGS. 4-6 illustrate example flowcharts of methods of forming a light metal based multi-layer substrate, according to various examples of the principles described herein.

### DETAILED DESCRIPTION

Light metal based substrates are increasingly being considered as the substrate of choice for forming housing parts for electronic devices due to their high strength-to-weight ratios and attractive aesthetics. However, they may have poor color stability, hardness, and chemical resistance. Various surface treatment processes may have to be performed on the light metal based substrates to make them suitable for use. This may, however, result in a longer production cycle time. Such processes may also affect the texture and appearance of the product and may result in high levels of volatile organic carbon (VOC) emissions, making them less environmentally friendly.

Aspects of the present subject matter relate to light metal based multi-layer substrates and methods for forming the substrates. For discussion purposes, a light metal based multi-layer substrate is interchangeably referred to as substrate hereinafter.

In one example, a substrate comprises a light metal layer, an oxidized layer formed on the light metal layer, and a ceramic-polymer hybrid layer formed on the oxidized layer. The presence of the oxidized layer substantially increases the chemical resistance of the light metal layer and also provides protection against wear and acts as a thermal and electrical insulation. The ceramic-polymer hybrid layer further makes the substrate more durable and corrosion resistant. The ceramic-polymer hybrid layer can additionally provide color stability and insulation to the substrate.

In one example, the oxidized layer is formed integrally on the light metal layer by an electrochemical process, such as plasma electrolytic oxidation (PEO). As a result, the oxidized layer has greater adhesion to the light metal layer than deposited coatings of oxidized metal. In one example, the oxidized layer is formed on two opposing sides of the light metal layer. Further, the ceramic-polymer hybrid layer may be formed on the oxidized layer on both the opposing sides of the light metal layer.

In one example, the substrate may further have an outer layer. The outer layer may be provided on one side of the substrate. In one implementation, the outer layer may be a finishing layer. In another implementation, the outer layer may be composed of a barrier layer covered by a finishing layer. The finishing layer can be used to provide various textural finishes and other properties, such as finger print resistance, stain resistance, spillage resistance, anti-bacterial, and the like, to the substrate. Accordingly, the finishing layer may be formed as a thermally cured layer or an Ultra Violet (UV) light cured coating. The barrier layer may be provided as an additional barrier for safeguarding the substrate.

The substrates, as per different aspects of the present subject matter, may be used to form housing parts for an electronic device, such as a laptop, a tablet, a mobile communication device, a portable hard disk, a portable music player, and the like.

In the following description, for purposes of explanation, numerous specific details are set forth in order to provide an understanding of the present systems and methods. It will be apparent, however, that the present apparatus, systems, and methods are merely examples. In the figures the same reference numerals are used to indicate like components, but they may not be identical.

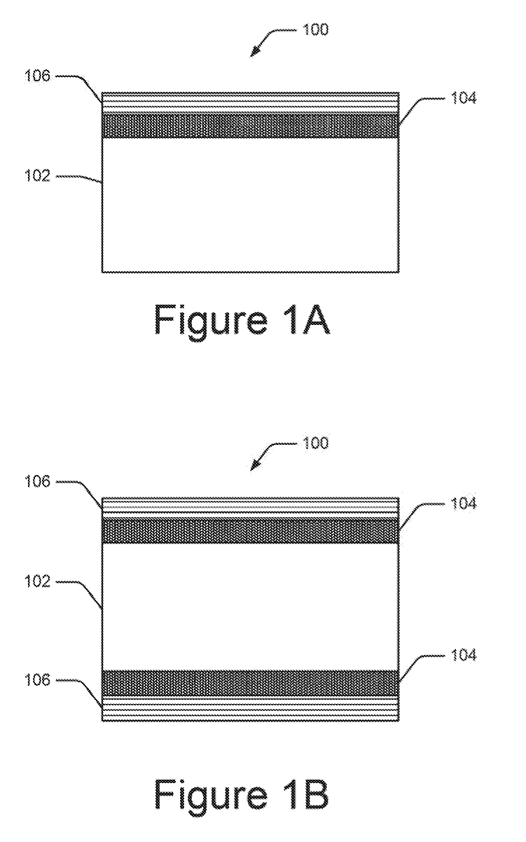

FIGS. 1A and 1B illustrate light metal based multi-layer substrates 100, according to various examples of the principles described herein. The substrate 100 includes a light metal layer 102, an oxidized layer 104 formed on the light metal layer 102 and a ceramic-polymer hybrid layer 106 formed over the oxidized layer 104. In one example, the light metal is selected from magnesium, aluminum, zinc, titanium, lithium, and alloys thereof.

In one example, the oxidized layer 104 with the ceramic-polymer hybrid layer 106 may be formed on one surface of the light metal layer 102, as shown in FIG. 1A. In another example, the oxidized layer 104 with the ceramic-polymer hybrid layer 106 may be formed on two opposing surfaces of the light metal layer 102 as shown in FIG. 1B.

In one example, to form the substrate 100, a light metal sheet may be subjected to electrochemical oxidation, such as plasma electrolytic oxidation, to form the oxidized layer 104 over an exposed surface of the light metal sheet. The non-oxidized portion of the light metal sheet may form the light metal layer 102. In one example, the light metal sheet may have a thickness in a range of about 0.4 to 2.0 millimeters.

For oxidation, the light metal sheet may be placed in an electrolytic solution comprising electrolytes selected from sodium silicate, metal phosphate, potassium fluoride, potassium hydroxide, sodium hydroxide, fluorozirconate, sodium hexametaphosphate, sodium fluoride, ferric ammonium oxalate, phosphoric acid salt, graphite powder, silicon dioxide powder, aluminum oxide powder, dispersant, metal powder, polyethylene oxide alkylphenolic ether, and combinations thereof. The electrolytes may be present in a concentration of 0.05-15% by weight of the adding dosage of water. A voltage in the range of 150-450 V may be passed across the electrolytic solution having the light metal sheet placed in it to form the oxidized layer 104. In one example, the voltage may be applied for about 3-20 minutes. The oxidized layer 104 thus formed may have a thickness in the range of about 1-15 micrometers in one example.

Further, the ceramic-polymer hybrid layer 106 may be a sol-gel polymer hybrid layer formed by sol-gel polymerization. The sol-gel polymerization includes applying a coating of a sol-gel on the oxidized layer 104 and drying the coating. In one example, the coating may be a spray coating formed by spraying the sol-gel on the oxidized layer 104. In another example, the coating may be a dip coating formed by dipping the substrate comprising the light metal layer 102 and the oxidized layer 104 in the sol-gel.

A sol is a colloidal suspension of polymer precursor particles in a liquid medium, such as water. In one example, the sol may include about 30% polymer precursor particles by weight. The precursor particles undergo reactions, such as hydrolysis and condensation polymerization, to form a gel upon activation. Activation can be performed, for example, by adding water, in acidic, basic, or neutral conditions, depending on the precursor used. In one example, 0.1M hydrochloric acid (HCl) solution may be used for activation of the sol to form a gel. The gel thus formed is a dilute cross-linked polymer system, which exhibits no flow when in the steady state. The gel can be coated over the oxidized layer 104, for example, by spray or dip coating, and then dried.

Upon drying, a hard, glass-like film is obtained, which has a ceramic like appearance, and is hence referred to as a ceramic coating. In one example, in addition to the precursors, various polymers may also be added in the sol so that a matrix including the ceramic and polymers is formed upon drying. This matrix can be referred to as a ceramic-polymer hybrid layer or sol-gel polymer hybrid layer. In one example, the ceramic-polymer hybrid layer 106 thus formed may be of a thickness in a range of about 2-15 micrometers.

In one example, the ceramic sol-gel comprises precursors selected from tetraethylorthosilicate (TEOS), glycidoxypropyltriethoxysilane (GPTMS). 3-aminopropyltriethoxysilane (APTES), ethacryloxypropyltrimethoxysilane, vinyltrimethylsiloxane (VTMS), diphenyldimethoxysilane (DPhDMS), zirconium isopropoxide (TPZ), and metal alkoxides. In one example, the polymers used in the ceramic sol-gel suspension are selected from polyacrylate, epoxy, acrylonitrile butadiene styrene (ABS), polycarbonate, polyurethane, fluoro-polymers, and combinations thereof.

In various implementations, outer layers of polymers, polymer-metal hybrids, or polymer-particulate hybrids may be additionally provided on at least one of the sides of the light metal based multi-layer substrate 100 as discussed below.

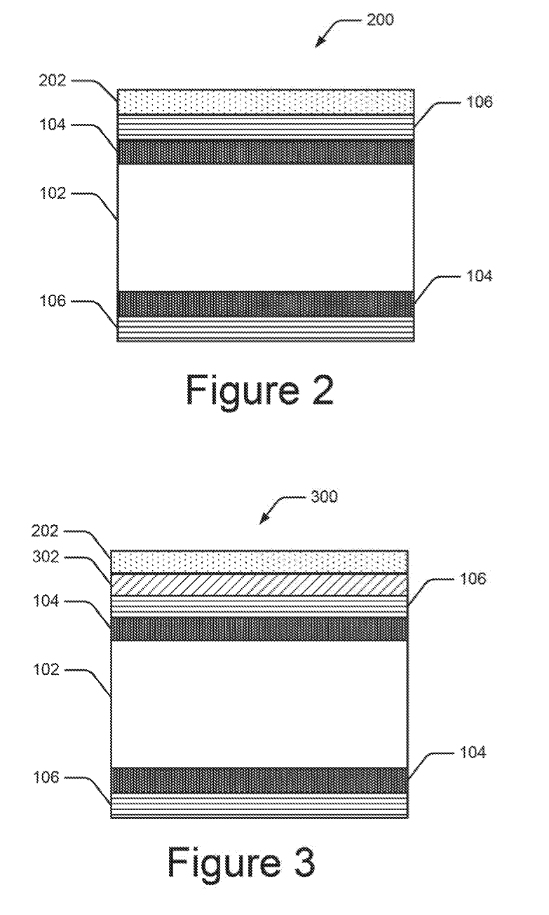

FIGS. 2 and 3 illustrate light metal based multi-layer substrates 200 and 300, according to various implementations of the principles described herein. The substrates 200 and 300 include outer layers in addition to the oxidized layer 104 and the ceramic-polymer hybrid layer 106.

In one implementation, as shown in FIG. 2, the outer layer of the substrate 200 is a finishing layer 202 formed over the ceramic-polymer hybrid layer 106. In one example, the finishing layer 202 may have a thickness in a range of about 5 to 20 micrometers. The finishing layer 202 can be one of a thermally cured polymer-particle layer and an Ultra Violet (UV) light cured polymer-particle layer.

In one example, urethane acrylate polymer with particulates, such as metal flakes, talc, or graphene, can be used to form a UV cured finishing layer 202. In one example, thermoplastic or thermosetting polymers with particulates, such as pearl powder or metal powders like powders of aluminum, silver, nickel, chromium, or stainless steel, can be used to form a thermally cured finishing layer 202.

In another implementation, as shown in FIG. 3, the outer layer of the substrate 300 includes a barrier layer 302 between the finishing layer 202 and the ceramic-polymer hybrid layer 106. The barrier layer 302 can be a dried or cured polymer layer with or without particulates. In one example, the barrier layer 302 has a thickness in a range of about 3 to 15 micrometers.

In one example, thermoplastic or thermosetting polymers with or without particulates, such as graphene, carbon nanotube, talc, clay, can be used to form the barrier layer 302.

The outer layers of the substrates 200 and 300 can provide a desired aesthetic appearance such as textural finishes and other properties, such as finger print resistance, stain resistance, spillage resistance, anti-bacterial, and the like. Further, the side of the light metal based multi-layer substrate 200 or 300 that does not have an outer layer may be fixed to an underlying housing part or a component of an electronic device, while the side of the multi-layer substrate 200 or 300 that has the outer layer can form the outer cover of the housing part or the component.

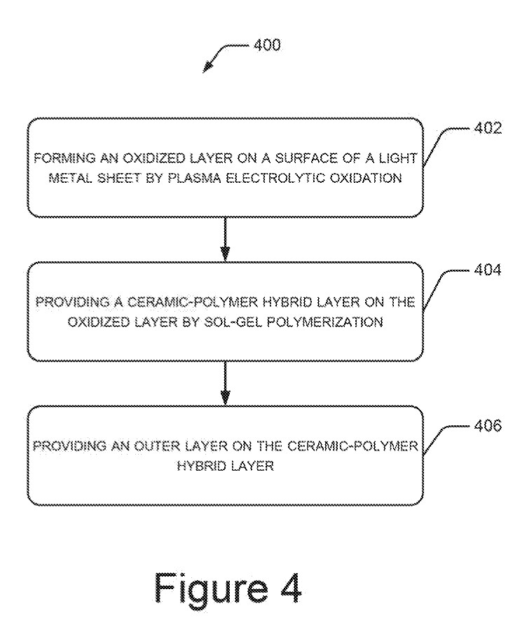

FIGS. 4-6 illustrate example flowcharts of methods of forming a light metal based multi-layer substrate, according to various examples of the principles described herein.

Aspects of the methods are described herein with reference to flowchart illustrations, and/or block diagrams of methods according to examples of the principles described herein. Some or all of the blocks of the flowchart illustrations and block diagrams, and combinations of blocks in the flowchart illustrations and block diagrams, may be implemented by computer usable program code. The computer usable program code may be provided to a processor of a general purpose computer, special purpose computer, or other programmable data processing apparatus to produce a machine such that the computer usable program code, when executed via, for example, a processor or other programmable data processing apparatus, implement the functions or acts specified in the flowchart and/or block diagram block or blocks. In one example, the computer usable program code may be embodied within a computer readable storage medium; the computer readable storage medium being part of the computer program product. In one example, the computer readable storage medium is a non-transitory computer readable medium.

Referring to FIG. 4, at block 402, an oxidized layer is formed on a surface of a light metal sheet by plasma electrolytic oxidation. The PEO process is an electrochemical process in which a controlled high-voltage alternating current is applied to a metal part submerged in an electrolytic bath. The process combines electrochemical oxidation with a high voltage spark treatment in an alkaline electrolyte, resulting in the formation of a physically protective oxide film on the metal surface to enhance wear and corrosion resistance as well as prolong the lifetime of the underlying light metal layer. Due to the high voltage and current, intense plasma is created on the surface of the metal. This plasma oxidizes the surface of the part and grows a nano-structured ceramic like oxide layer from the substrate material. Thus the oxidized layer, such as the oxidized layer 104, is integrally produced on a light metal layer, such as the light metal layer 102. Such an integrally produced oxidized layer has greater adhesion to the underlying metal layer than a deposited metal oxide layer. Hence, the oxidized layer 104 thus produced is more durable.

In one example, the light metal sheet may be made of, for example, magnesium, aluminum, titanium, lithium, zinc, or their alloys. In one example, the light metal sheet may be placed in an electrolytic solution and a voltage in a range of 150 to 450 volts may be applied across the light metal layer to oxidize an exposed surface of the light metal sheet. The oxidized layer thus formed, for example, the oxidized layer 104 of substrates 100, 200, or 300, can have a thickness in a range of about 1-15 micrometers. To form the oxidized layer on one surface of the light metal sheet, the opposing surface may be temporarily protected, for example, by an inert material.

At block 404, a ceramic-polymer hybrid layer, for example, the ceramic-polymer hybrid layer 106 of substrates 100, 200, or 300, is provided on the oxidized layer by sol-gel polymerization. In one example, the light metal layer 102 with the oxidized layer 104 may be dipped in a suspension of sol-gel and polymer to apply a ceramic-polymer hybrid coating and the dip coating may be dried to form the ceramic-polymer hybrid layer. In another example, a suspension of sol-gel and polymer may be applied on the oxidized layer 104 by spraying to form the ceramic-polymer hybrid coating and the coating may be dried to form the ceramic-polymer hybrid layer.

At block 406, an outer layer may be provided on the ceramic-polymer hybrid layer to provide various textural and functional finishes. In one example, the outer layer may be a finishing layer, such as the finishing layer 202. In another example, the outer layer may be a barrier layer 302 covered by the finishing layer 202.

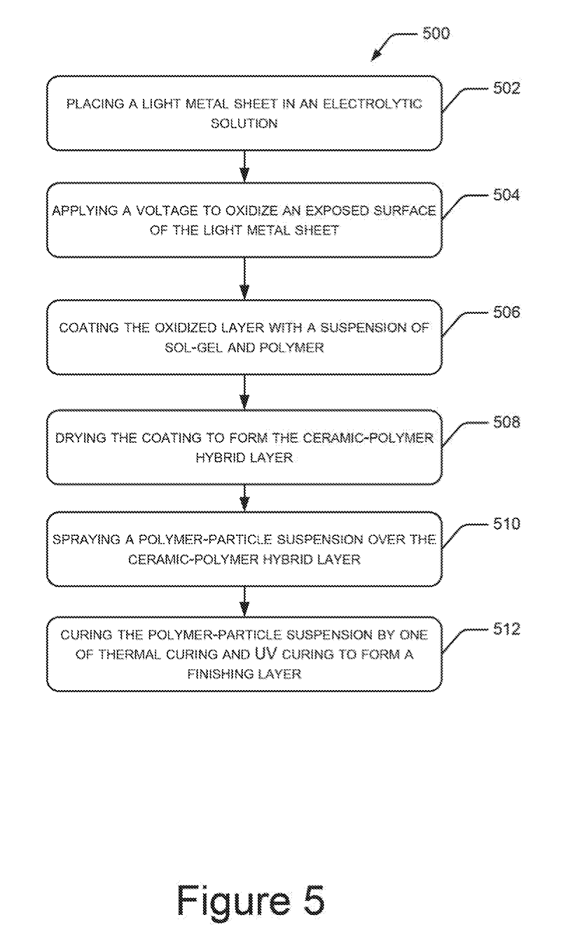

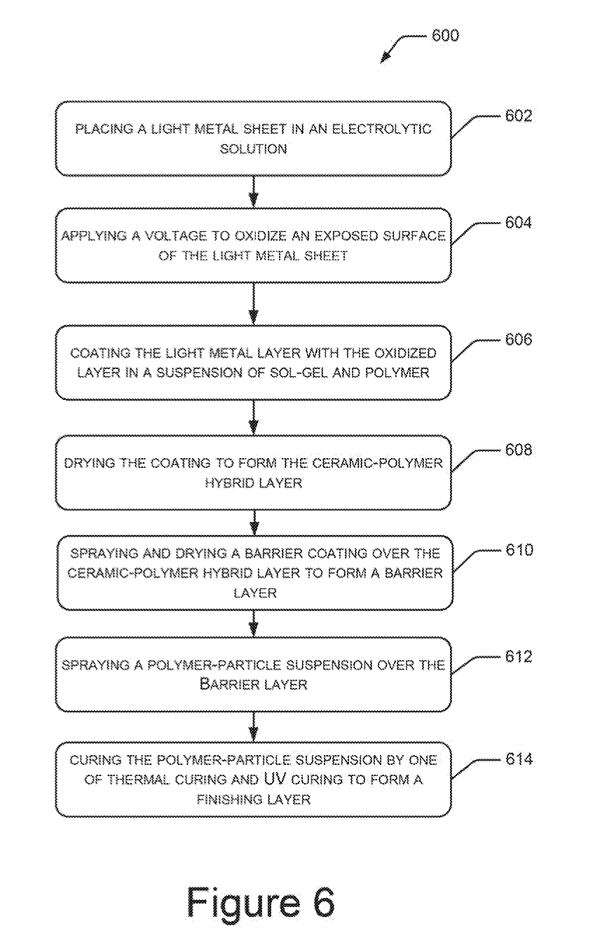

The light metal based multi-layer substrate thus formed is substantially more durable. The presence of the oxidized layer increases the chemical resistance of the light metal layer and also provides protection against wear and acts as a thermal and electrical insulation. The ceramic-polymer hybrid layer further increases the strength and corrosion resistance of the substrate and provides color stability and insulation to the substrate. Further, the process is faster and uses lesser energy than traditional processes of surface treatment. Additionally, the substrates formed as per the present subject matter may be provided with outer layers including a finishing layer as further discussed below with reference to FIGS. 5 and 6.

In one implementation, the method illustrated in FIG. 5 may be used to prepare the substrate 200 and the method illustrated in FIG. 6 may be used to prepare the substrate 300.

Referring to FIG. 5, at block 502, a light metal sheet is placed in an electrolytic solution for PEO. In one example, the electrolytes are selected from sodium silicate, metal phosphate, potassium fluoride, potassium hydroxide or sodium hydroxide, fluorozirconate, sodium hexametaphosphate, sodium fluoride, ferric ammonium oxalate, phosphoric acid salt, graphite powder, silicon dioxide powder, aluminum oxide powder, dispersant, metal powder, polyethylene oxide alkylphenolic ether, and combinations thereof. In one example, the electrolytes may be added at a dosage in a range of about 0.05-15% of the adding dosage of water

At block 504, a voltage is applied across the electrolyte having the light metal sheet to oxidize an exposed surface of the light metal sheet and form an oxidized layer, such as the oxidized layer 104. In an example, a voltage in a range of 150 to 450 Volts may be applied for a time duration of about 3-20 minutes to form an oxidized layer that is 1-15 micrometers thick. It will be understood that by varying the conditions of the PEO, such as the voltage, time, and electrolyte concentration, the thickness of the oxidized layer can be varied.

At block 506, the light metal layer with the oxidized layer is coated with a suspension of ceramic sol-gel and polymer. The coating may be applied by, for example, dip coating or spray coating. In one example, the ceramic sol-gel comprises precursors selected from tetraethylorthosilicate (TEOS), glycidoxypropyltriethoxysilane (GPTMS), 3-aminopropyltriethoxysilane (APTES), ethacryloxypropyltrimethoxysilane, vinyltrimethylsiloxane (VTMS), diphenyldimethoxysilane (DPhDMS), zirconium isopropoxide (TPZ), and metal alkoxides. In one example, the polymers used in the ceramic sol-gel suspension are selected from polyacrylate, epoxy, acrylonitrile butadiene styrene (ABS), polycarbonate, polyurethane, fluoro-polymers, and combinations thereof.

At block 508, the coating is dried to form the ceramic-polymer hybrid layer, such as the ceramic-polymer hybrid layer 106. In one example, the coating may be dried by air drying at temperature in a range of 60 to 140° C.

At block 510, a polymer-particle suspension coating is provided over the ceramic-polymer hybrid layer. In one example, the polymer-particle suspension coating is sprayed over the ceramic-polymer hybrid layer.

At block 512, the polymer-particle suspension coating is cured by one of thermal curing and UV curing to form a finishing layer, such as the finishing layer 202. In one example, urethane acrylate polymer with particulates, such as metal flakes, talc, or graphene, can be used to form a UV cured finishing layer. In one example, thermoplastic or thermosetting polymers with particulates, such as pearl powder or metal powders like powders of aluminum, silver, nickel, chromium, or stainless steel, can be used to form a thermally cured finishing layer.

In one example, for UV curing, the polymer-particle suspension coating is baked at 60° C. for 5-10 minutes and then exposed to UV irradiation for about 3 to 60 seconds. In another example, for thermal curing, the polymer-particle suspension coating is exposed to a temperature in a range of about 60-140° C. for about 20 to 40 minutes to form the finishing layer.

Referring to FIG. 6, blocks 602-608 to form a substrate with a light metal layer, an oxidized layer and a ceramic-polymer hybrid layer over the oxidized layer, are analogous to blocks 502-508 of FIG. 5. Thus, at block 602, a light metal sheet is placed in an electrolytic solution. At block 604, a voltage is applied across the light metal sheet to oxidize an exposed surface of the light metal sheet. At block 606, the light metal layer is coated with the oxidized layer in a suspension of ceramic sol-gel and polymer. At block 608, the coating is dried to form the ceramic-polymer hybrid layer.

Further, at block 610, a barrier coating is sprayed over the ceramic-polymer hybrid layer and dried to form a barrier layer. In one example, thermoplastic or thermosetting polymers with or without particulates, such as graphene, carbon nanotube, talc, clay, can be used to form the barrier layer. In one example, the barrier coating may be dried at a temperature in a range of about 60-140° C.

The blocks 612 and 614, for forming a finishing layer, are analogous to blocks 510 and 512, respectively. Thus, at block 612, a polymer-particle suspension is sprayed over the barrier layer and at block 614 the polymer-particle suspension is cured by one of thermal curing and UV curing to form the finishing layer.

The preceding description has been presented to illustrate and describe examples of the principles described. This description is not intended to be exhaustive or to limit these principles to any precise form disclosed. Many modifications and variations are possible in light of the above teaching.

What is claimed is:

1. A substrate comprising:
a light metal layer,
an oxidized layer formed on the light metal layer, wherein the oxidized layer is a plasma electrolytic oxidation layer; and
a ceramic-polymer hybrid layer formed over the oxidized layer.

2. The substrate of claim 1 further comprising a finishing layer formed over the ceramic-polymer hybrid layer, wherein the finishing layer is one of a thermally cured polymer-particle layer and an Ultra Violet (UV) light cured polymer-particle layer.

3. The substrate of claim 2, further comprising a barrier layer between the finishing layer and the ceramic-polymer hybrid layer.

4. The substrate of claim 1, wherein the light metal is selected from magnesium, aluminum, zinc, titanium, lithium, and alloys thereof.

5. The substrate of claim 1, wherein the oxidized layer has a thickness in a range of about 1-15 micrometers.

6. A method comprising:
forming an oxidized layer on a surface of a light metal sheet by plasma electrolytic oxidation;
providing a ceramic-polymer hybrid layer on the oxidized layer by sol-gel polymerization; and
providing an outer layer on the ceramic-polymer hybrid layer.

7. The method of claim 6, wherein providing the ceramic-polymer hybrid layer comprises:
coating the oxidized layer with a suspension of sol-gel and polymer, wherein the coating is one of a spray coating and a dip coating; and
drying the coating to form the ceramic-polymer hybrid layer.

8. The method of claim 7, wherein
the sol-gel comprises precursors selected from tetraethylorthosilicate (TEOS), glycidoxypropyltriethoxysilane (GPTMS), 3-aminopropytriethoxysilane (APTES), ethacryloxypropyltrimethoxysilane, vinyltrimethyisiloxane (VTMS), diphenyldimethoxysilane (DPhDMS), zirconium isopropoxide (TPZ), metal alkoxides, and combinations thereof; and
the polymer is selected from polyacrylate, epoxy, acrylonitrile butadiene styrene (ABS), polycarbonate, polyurethane, fluoro-polymers, and combinations thereof.

9. The method of claim 6, wherein providing the outer layer comprises:
spraying a polymer-particle suspension over the ceramic-polymer hybrid layer; and
curing the polymer-particle suspension by one of thermal curing and UV curing.

10. The method of claim 6, wherein providing the outer layer comprises:
forming a barrier layer over the ceramic-polymer hybrid layer by spray drying;
spraying a polymer-particle suspension over the barrier layer; and
curing the polymer-particle suspension by one of thermal curing and UV curing.

11. The method of claim 6, wherein the plasma electrolytic oxidation comprises:
placing the light metal sheet in an electrolytic solution; and
applying a voltage in a range of 150 to 450 volts to oxidize an exposed surface of the light metal sheet.

12. A substrate comprising:
a light metal layer;
an oxidized layer formed electrochemically on the light metal layer;
a sol-gel polymer hybrid layer formed on the oxidized layer; and
an outer layer deposited on the sol-gel polymer hybrid layer, wherein the outer layer includes one of:
a finishing layer; and
a barrier layer covered by the finishing layer.

13. The substrate of claim 12, wherein the finishing layer is a UV cured polymer-particle layer, wherein the polymer is a urethane acrylate polymer, and wherein the particle is selected from metal flakes, talc, graphene, and combinations thereof.

14. The substrate of claim 12, wherein the finishing layer is a thermally cured polymer-particle layer,
wherein the polymer is selected from polyacrylate, celluloid, polyethylene, polypropylene (PP), polyvinyl chloride (PVC), chlorinated polyvinyl chloride (CPVC), polystyrene (PS), epoxy, acrylonitrile butadiene styrene (ABS), potycarbonate, polyurethane, polybutylene (PB), poly vinylidene fluoride (PVDF), fluoro-polymers, nylon, polytetrafluoroethylene, Teflon, polyacetylenes, polypyrrol, polythiophene, polyfuran, poly(p-phenylene), polyaniline, poly(ethylendioxythiophene), poly(phenylene)vinylidene, poly(dialkylfluorene, and combinations thereof; and
wherein the particle is selected from pearl powder, aluminum powder, silver powder, nickel powder, chromium powder, stainless steel powder, and combinations thereof.

15. The substrate of claim 12, wherein the barrier layer comprises:
particles selected from graphene, carbon nanotube, talc, days, and combination thereof; and
polymer selected from polyacrylate, celluloid, polyethylene, polypropylene (PP), polyvinyl chloride (PVC), chlorinated polyvinyl chloride (CPVC), polystyrene (PS), epoxy, acrylonitrile butadiene styrene (ABS), polycarbonate, polyurethane, polybutylene (PB), poly vinylidene fluoride (PVDF), fluoro-polymers, nylon, polytetrafluoroethylene, Teflon, polyacetylenes, polypyrrol, polythiophene, polyfuran, poly(p-phenylene), polyaniline, poly(ethylendioxythiophene), poly(phenylene)vinylidene, poly(dialkylfluorene), and combinations thereof.
